(19) United States
(12) Patent Application Publication
(10) Pub. No.: US 2025/0004776 A1
(43) Pub. Date: Jan. 2, 2025

(54) INSTRUCTION FLOW REGULATOR FOR A PROCESSING UNIT

(71) Applicant: ADVANCED MICRO DEVICES, INC., Santa Clara, CA (US)

(72) Inventors: Wei Huang, Shanghai (CN); ZhongXiang Luo, Shanghai (CN); ShengNan Xu, Shanghai (CN); LingPeng Jin, Shanghai (CN)

(21) Appl. No.: 18/216,201

(22) Filed: Jun. 29, 2023

(51) Int. Cl. G06F 9/48

(52) U.S. Cl. CPC G06F 9/4812

(57) ABSTRACT

A processing unit monitors, over a sliding time window, the number of instructions dispatched for execution at the processing unit. In response to the number of instructions exceeding a threshold, the processing unit throttles (e.g., pauses) the dispatch of instructions for a specified amount of time. The processing unit thus ensures that the number of dispatched instructions does not change too rapidly in too short a period of time reducing the likelihood of sudden changes in processing unit current, without unduly impacting the performance of the processing unit across all workloads.

### BACKGROUND

Modern processing units sometimes experience sudden large variation in workloads and corresponding processing demands. For example, a graphics processing unit (GPU) sometimes experiences low processing demands, such as when the corresponding processing system is issuing relatively few or simple draw commands to the GPU, followed suddenly by high processing demands, when the processing system issues a much higher or more complex draw commands. These sudden changes in processing unit workload results in a large increase in current drawn by the processing unit over a relatively short period of time, and in some cases this large increase in the current causes performance problems at the processing unit, such as a temporary loss of functionality by the processing unit. Furthermore, existing approaches to regulating the amount of current drawn by a processing unit have undesirable limitations. For example, some processing units employ complex monitoring circuits to monitor and regulate the voltage and current drawn by the processing unit, but such sometimes limit the performance of the processing unit for all workloads.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing unit that employs an instruction flow regulator to regulate the number of instructions executed by the processing unit over a specified time window in accordance with some embodiments.

FIG. 2 is a diagram illustrating an example of the instruction flow regulator of FIG. 1 regulating the number of instructions executed by the processing unit in accordance with some embodiments.

FIG. 3 is a block diagram of the instruction flow regulator of FIG. 1 in accordance with some embodiments.

FIG. 4 is a flow diagram of a method of regulating instruction flow at a processing unit in accordance with some embodiments.

### DETAILED DESCRIPTION

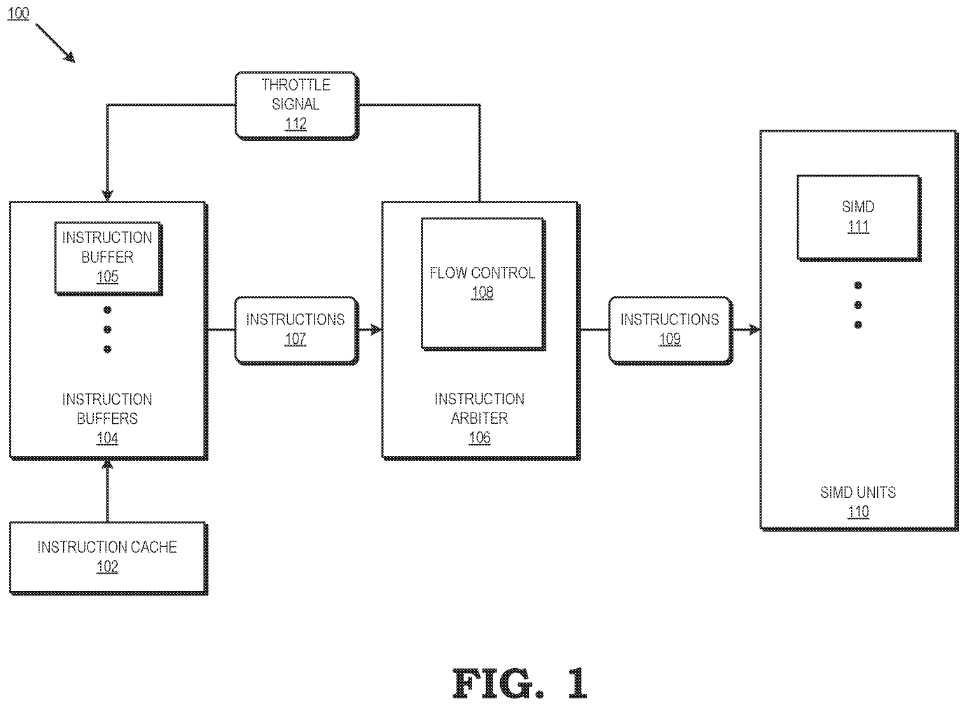

FIGS. 1-4 illustrate techniques for regulating the flow of instructions executing at a processing unit over time. The processing unit monitors, over a sliding time window, the number of instructions dispatched for execution at the processing unit. In response to the number of instructions exceeding a threshold, the processing unit throttles (e.g., pauses) the dispatch of instructions for a specified amount of time. The processing unit thus ensures that the number of dispatched instructions does not change too rapidly in too short a period of time reducing the likelihood of sudden changes in processing unit current, without unduly impacting the performance of the processing unit across all workloads.

To illustrate, as noted above, in at least some cases a processing unit experiences sudden changes in workload. These sudden changes are manifested by sudden changes in the number of instructions dispatched by the processing unit for execution. Accordingly, if the flow of dispatched instructions is unregulated, there is a sudden change in the activity of the circuits that execute the instructions, and thus a sudden change in the amount of current drawn at the processing unit. Using the techniques described herein, a processing unit employs an instruction flow regulator to ensure that the number of dispatched instructions at the processing unit does not change too rapidly over too short a period of time. This in turn ensures that the current drawn at the processing unit does not change rapidly over a short period of time, thus reducing performance errors at the processing unit.

Further, in at least some embodiments the instruction flow regulator employs a dynamic threshold to regulate the dispatch of instructions, so that the rate of instruction dispatch is gradually increased over time. For example, in some embodiments the instruction flow regulator throttles, for a period of time, the dispatch of instructions in response to the number of instructions in a time window exceeding a threshold. In addition, the instruction flow regulator increases the threshold. After resuming the dispatch of instructions, the instruction flow regulator uses the increased threshold to determine whether to throttle instruction dispatch for a subsequent window of time. That is, the instruction flow regulator gradually increases the threshold that governs instruction dispatch throttling. This allows the processing unit to prevent sudden current changes while maintaining a relatively high rate of instruction dispatch, thus preventing errors at the processing unit while maintaining relatively high performance.

In some embodiments, the instruction flow regulator bases the throttling of instructions only on instructions of a specified type, such as instructions that are expected to cause a relatively large increase in processing activity, and thus in the current drawn by the processing unit. For example, in some embodiments a processing unit is configured to execute both scalar instructions (that is, instructions that use scalar operands) and vector instructions (that is, instructions that use vector operands). The scalar instructions, when executed, result in a relatively low amount of circuit activity at the processing unit, while execution of the vector instructions results in a relatively high amount of circuit activity at the processing unit. Accordingly, in some embodiments the instruction flow regulator determines whether to throttle the dispatch of instructions based only on the vector instructions (e.g., whether the number of vector instructions over the time window exceeds the specified threshold), and not based on the scalar instructions. The instruction flow regulator thus regulates the amount of circuit activity, and corresponding current demand, at the processing unit while providing for a relatively high rate of instruction flow.

It will be appreciated that at least some of the examples above, and the example embodiments set forth below, are described with respect to a graphics processing unit (GPU), and further that the techniques described herein apply to different types of processors, processing units, and processing systems. For example, in some embodiments the instruction flow control techniques described herein are implemented using any of a variety of parallel processors (e.g., vector processors, graphics processing units (GPUs), general-purpose GPUs (GPGPUs), non-scalar processors, highly-parallel processors, artificial intelligence (AI) processors, inference engines, machine learning processors, other multithreaded processing units, and the like).

FIG. 1 illustrates a block diagram of a GPU 100 that implements instruction flow control in accordance with some embodiments. In some embodiments, the GPU 100 is part of a processing system that is configured to execute sets of instructions (e.g., software programs) to carry out specified tasks on behalf of an electronic device. Accordingly, in different embodiments the GPU 100 is part of a desktop computer, laptop computer, server, tablet, smartphone, game console, and the like. The GPU 100 is generally configured to receive commands (e.g., draw commands) from another processing unit (not shown), such as a central processing unit (CPU). Based on the received commands, the GPU 100 identifies an executes corresponding sets of instructions to carry out operations, such as scalar operations, vector operations, and the like, based on the received commands.

To support execution of the sets of instructions, the processor GPU 100 includes an instruction cache 102, a scheduler 103, instruction buffers 104, an instruction arbiter 106, and single-instruction multiple-data (SIMD) units 110. The instruction cache 102 is a memory structure generally configured to store instructions for execution. For example, in some embodiments a command processor (not shown) or other circuitry of the GPU 100 identifies sets of instructions for execution based on commands received from a CPU, and the command processor stores the instructions to be executed at the instruction cache 102.

The scheduler 103 is generally configured to separate the instructions to be executed into different groups of threads, wherein the groups are referred to as wavefronts, and schedule the wavefronts for execution as described further herein. The instruction buffers 104 include a plurality of instruction buffers (e.g., instruction buffer 105), with each instruction buffer configured to store a set of instructions for execution. In some embodiments, each of the instruction buffers 104 stores the instructions for a different wavefront to be executed, with the scheduler 103 assigning the different wavefronts to different ones of the instruction buffers 104. In some embodiments, the instruction buffers 104 includes an arbiter (not shown) that receives instructions from the instruction cache 102, identifies (based on information provided by the scheduler 103) the wavefront corresponding to the received instruction, and stores the instruction at the one of the instruction buffers 104 assigned to the identified wavefront.

The SIMD units 110 includes a plurality of SIMD units (e.g., SIMD unit 111). Each of the SIMD units 110 is configured to execute received instructions, such as vector instructions (that is, instructions having vector operands), scalar instructions (that is, instructions having scalar operands), and the like, or a combination thereof. Accordingly, each of the SIMD units 110 includes circuitry to carry out the corresponding instructions, such as scalar registers to store scalar operands, vector registers to store vector operands, scalar and vector arithmetic logic units (ALUs) to carry out arithmetic operations indicated by the corresponding instructions, local data stores to store data for operations, and the like.

The instruction arbiter 106 is configured to receive instructions (illustrated as instructions 107) from the instruction buffers 104, identify for each received instruction the instruction's assigned SIMD, and send the instruction to the identified one of the SIMD units 110 for execution. To illustrate, in some embodiments the scheduler 103 assigns each wavefront to a corresponding one of the instruction buffers 104, and also assigns to the wavefront a corresponding one of the SIMD units 110. The scheduler 103 indicates the assignments to the instruction arbiter 106. For example, the scheduler 103 indicates to the instruction arbiter 106, for each wavefront, the instruction buffer (of the instruction buffers 104) assigned to the wavefront and the SIMD unit assigned to the wavefront. In response to receiving an instruction from one of the instruction buffers 104, the instruction arbiter identifies the SIMD unit assigned to the corresponding wavefront and sends the instruction to the identified SIMD unit for execution. The instructions sent to the SIMD units 110 are represented at FIG. 1 as instructions 109.

The instruction arbiter 106 is also configured to throttle the dispatch of instructions from the instruction buffers 104 via the use of a throttle control signal 112. As used herein, throttling of instructions refers to temporarily pausing of the dispatch of instructions, so that no instructions are dispatched while instructions are throttled. To illustrate, in some embodiments, when the throttle control signal 112 is negated, the instruction buffers 104 are configured to provide up to one instruction for each specified unit of time, referred to as a cycle. In some embodiments, this cycle corresponds to a clock cycle of a clock signal used to control the instruction buffers 104 and the arbiter 106, such that up to one instruction is provided per clock cycle. When the throttle control signal is asserted, the instruction buffers 104 do not provide any instructions to the instruction arbiter 106, and therefore no instructions are dispatched to the SIMD units 110. Thus, by asserting the throttle control signal 112, the instruction arbiter 106 prevents the dispatch of (i.e., throttles) instructions to the SIMD units 110.

To control the throttle control signal 112, and thus the throttling of instructions, the instruction arbiter 106 includes flow control circuitry 108. In particular, the flow control circuitry 108 is configured to monitor the number of instructions over a sliding time window. For example, in some embodiments, for each cycle the flow control circuitry 108 identifies the number of instructions 107 provided by the instruction buffers 104 over the previous N cycles, where N is an integer. The flow control circuitry 108 compares the identified number of instructions to a specified threshold, referred to herein as the instruction threshold. In response to the identifier number of instructions matching or exceeding the instruction threshold, the flow control circuitry 108 asserts the throttle control signal for a specified number of cycles (e.g., M cycles, where M is an integer). After the specified number of cycles have elapsed, the flow control circuitry 108 negates the throttle control signal 112, thereby resuming provision of instructions from the instruction buffers 104 to the instruction arbiter 106, and thus resuming the dispatch of instructions to the SIMD units 110.

The flow control circuitry 108 is employed by the GPU 100 to ensure the SIMD units 110 do not experience a rapid rise in circuit activity, with a corresponding rapid change in the current drawn by the SIMD units 110. To illustrate, in some embodiments the instruction threshold is expressed as a percentage of the maximum workload (e.g., a maximum number) of instructions that are able to be concurrently executed at the SIMD units 110. The instruction threshold is initially set to a relatively low value (e.g., 50%) and is increased by a specified step size (e.g., 10%) each time the throttle control signal is asserted, until a maximum value of the threshold (e.g., 100%) is reached. This ensures that the number of instructions 109 dispatched to the SIMD units 110 over time is increased gradually, even when the number of instructions stored at the instruction buffers 104 rises rapidly. The gradual increase in rate of instruction dispatch prevents rapid changes in circuit activity and current drawn by the SIMD units 110, thus preventing errors in operation that result from rapid current changes. Further, because the instruction threshold is gradually increased up to the maximum workload of instructions, a relatively high level of performance at the GPU 100 is maintained.

In some embodiments, different instructions executed by the SIMD units 110 result in different corresponding levels of circuit activity, and corresponding different changes in the current drawn by the SIMD units 110. For example, in some embodiments the SIMD units 110 execute vector instructions that result in a higher level of circuit activity (and higher amount of current) at the SIMD units 110 and execute scalar instructions that result in a lower level of circuit activity (and lower amount of current drawn) at the SIMD units 110. In some cases, throttling based on instructions that result in lower levels of circuit activity negatively impacts the performance of the GPU 100, without a corresponding benefit in preventing large current swings at the SIMD units 110. Accordingly, in some embodiments the flow control circuitry 108 is configured to throttle instructions based only on instructions of a specified type (or set of types). Thus, for example, in some embodiments the flow control circuitry 108 is configured to monitor only the number of vector instructions provided by the instruction buffers 104 over the time window, and not to monitor the number of scalar instructions. Thus, in some embodiments the flow control circuitry 108 only asserts the throttle control signal in response to the number of provided vector instructions over the time window exceeding the specified threshold and ignores the provided scalar instructions during the time window.

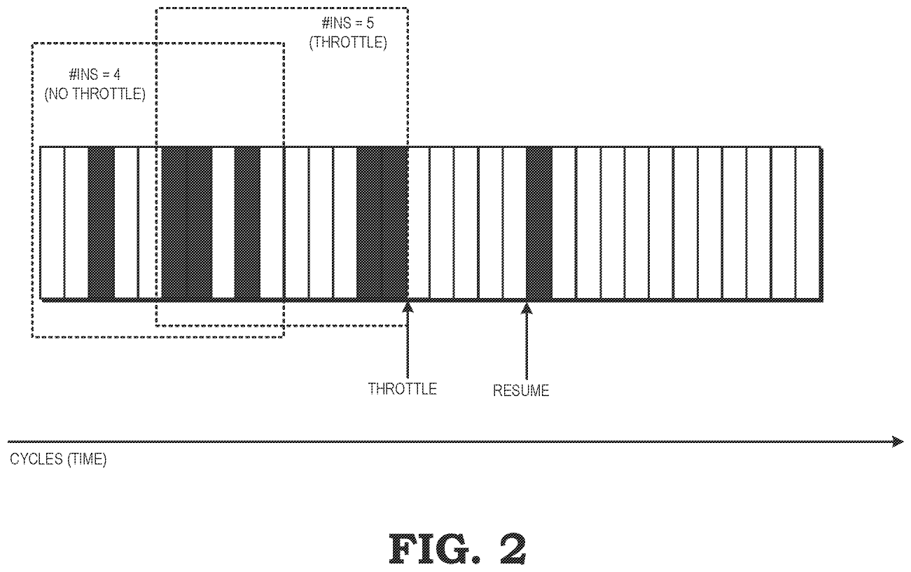

FIG. 2 illustrates a diagram of an example operation of the flow control circuitry 108 in accordance with some embodiments. In particular, FIG. 2 illustrates an axis 220, representing time, and in particular representing cycles of operation at the flow control circuitry 108. An individual cycle at the flow control circuitry 108 is represented by a rectangle, with an unshaded (unfilled) rectangle indicating no instruction was received at the instruction arbiter 106 for that cycle, and a shaded (filled) rectangle indicating an instruction was received at the instruction arbiter 106 for that cycle. Thus, for example, cycle 225 is represented by an unshaded rectangle, indicating no instruction was received at the instruction arbiter 106 for that cycle. In contrast, cycle 226 is represented by a shaded rectangle, indicating that the instruction arbiter 106 received an instruction during cycle 226.

In addition, FIG. 2 illustrates two different instances of a sliding time window, designated instances 221 and 222. That is, instance 221 is the time window at one point in time, while instance 222 is the time window at a different, later point in time. In the depicted example, the time window covers ten cycles. That is, the time window encompasses the current cycle as well as the immediately previous nine cycles.

The flow control circuitry 108 is configured to identify, for each instance of the time window, the number of instructions received by the instruction arbiter 106 for dispatch to the SIMD units 110. The flow control circuitry 108 compares the identified number of instructions to a specified instruction throttling threshold and, if the identified number of instructions matches the instruction throttling threshold, throttles the provision of instructions from the instruction buffers 104. For the example of FIG. 2, it is assumed that the instruction throttling threshold is five instructions.

For instance 221 of the time window the flow control circuitry 108 identifies that the instruction arbiter 106 has received four instructions for dispatch to the SIMD units 110. Thus, the number of received instructions is below the instruction throttling threshold, and the flow control circuitry 108 maintains the throttle control signal 112 in a negated state, allowing instructions to continue to flow from the instruction buffers 104. Subsequently, for instance 222 of the time window the flow control circuitry 108 identifies that instruction arbiter 106 has received five instructions for dispatch to the SIMD units 110. Thus, the number of received instructions matches the instruction throttling threshold. In response, at time 223 the flow control circuitry 108 asserts the throttle control signal 112. Responsive to assertion of the throttle control signal 112, the instruction buffers 104 stop sending instructions. After a specified number of cycles (five cycles in the example of FIG. 2) the flow control circuitry 108 negates the throttle control signal 112. Accordingly, at time 224, the instruction buffers 104 resume provision of instructions to the instruction arbiter 106. Thus, in the example of FIG. 2, the flow control circuitry 108 temporarily pauses the provision of instructions to the SIMD units 110 when the rate of increase of received instructions is too high. This ensures that the SIMD units 110 do not experience a sudden change in circuit activity, and thereby prevents errors that result from such sudden changes.

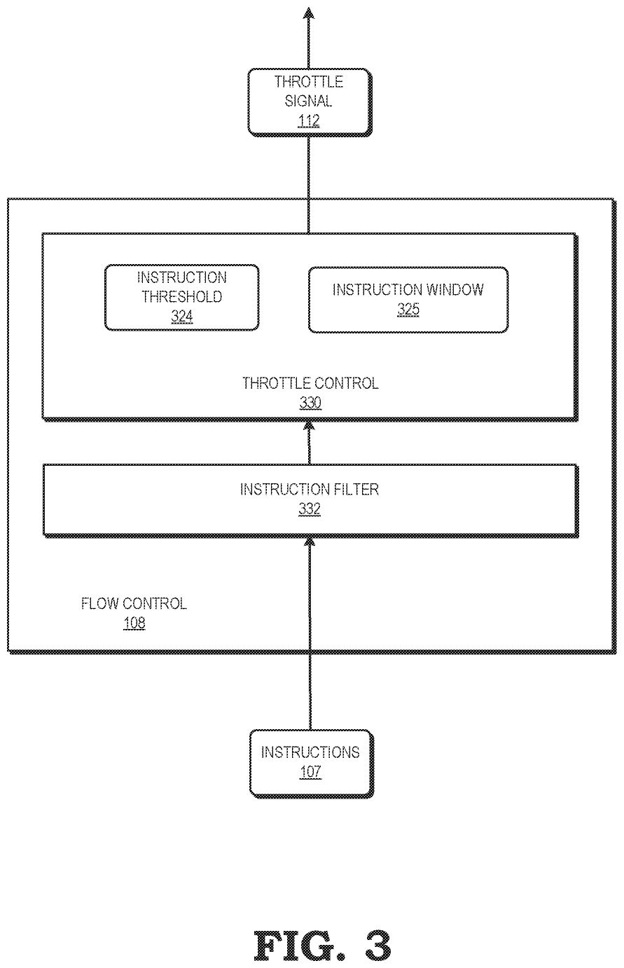

FIG. 3 illustrates a block diagram of the flow control circuitry 108 in accordance with some embodiments. In the illustrated example, the flow control circuitry 108 includes throttle control circuitry 330 and an instruction filter 332. The throttle control circuitry 330 is a set of one or more circuits that collectively are configured to monitor a number of received instructions over an instruction window 325. For example, in some embodiments the instruction window 325 is implemented by a counter (not shown) that is, for an initial period (e.g., 10 cycles) incremented for each cycle wherein the throttle control circuitry 330 receives an instruction. Subsequent to the initial period, the counter is incremented for each cycle wherein the throttle control circuitry 330 receives an instruction and is decremented for each cycle wherein the throttle control circuitry 330 does not receive an instruction (but not below a specified value such as zero). The throttle control circuitry 330 thus keeps a running total of the number of instructions received over the last N cycles, where N is an integer. Furthermore, in some embodiments N is a programmable value.

The throttle control circuitry 330 is further configured to compare, for each cycle, the number of received instructions over the instruction window 325 to an instruction threshold 324. Based on the comparison, the throttle control circuitry 330 sets the state of the throttle control signal 112. In particular, in response to the number of received instructions being below the instruction threshold 324, the throttle control circuitry 330 negates the throttle control signal 112, so that the instruction buffers 104 continue to provide instructions for dispatch. In response to the number of received instructions over the instruction window 325 matching or exceeding the instruction threshold 324, the throttle control circuitry 330 asserts the throttle control signal 112, thus throttling the provision of instructions from the instruction buffers 104. After a specified amount of time (e.g., M cycles, where M is an integer), the throttle control circuitry 330 negates the throttle control signal 112, resuming the provision of instructions. In some embodiments, the instruction threshold 324 is a programmable value.

In some embodiments, the throttle control circuitry 330 is configured to adjust the instruction threshold 324 each time the threshold is matched or exceeded. For example, in some embodiments the instruction threshold 324 is set to an initial value of fifty percent of the maximum workload of instructions that the SIMD units 110 are able to concurrently execute. In response to the number of received instructions over the instruction window 325 matching or exceeding the instruction threshold 324, the throttle control circuitry 330 adjusts the instruction threshold 324 by a specified step size (e.g., ten percent). Thus, each time the number of received instructions over the instruction window 325 matching or exceeding the instruction threshold 324 the throttle control circuitry 330 adjusts the instruction threshold 324 until a maximum value (e.g., 100 percent) is reached. In this way, the throttle control circuitry 330 allows the number of instructions provided by the instruction buffers 104 to gradually increase over time, thereby maintaining a high level of instruction execution performance at the GPU 100 while preventing rapid increases in the amount of current drawn by the SIMD units 110. In some embodiments, the step size is a programmable value. For example, in some embodiments the step size is set based on a processor executing an instruction provided by an operating system or application.

The instruction filter 332 is a set of one or more circuits collectively configured to filter instructions of one or more specified types from being provided to the throttle control circuitry 330. The instruction filter 332 thus ensures that only instructions of a particular type (or of a set of particular types) are used by the throttle control circuitry 330 to determine whether to throttle the dispatch of instructions. For example, in some embodiments the instruction filter 332 is configured to filter scalar instructions, so that only vector instructions are provided to the throttle control circuitry 330. Thus, the throttle control circuitry 330 determines whether to negate or assert the throttle control signal 112 based only on vector instructions, as those instructions are expected to result in more circuit activity at the SIMD units 110.

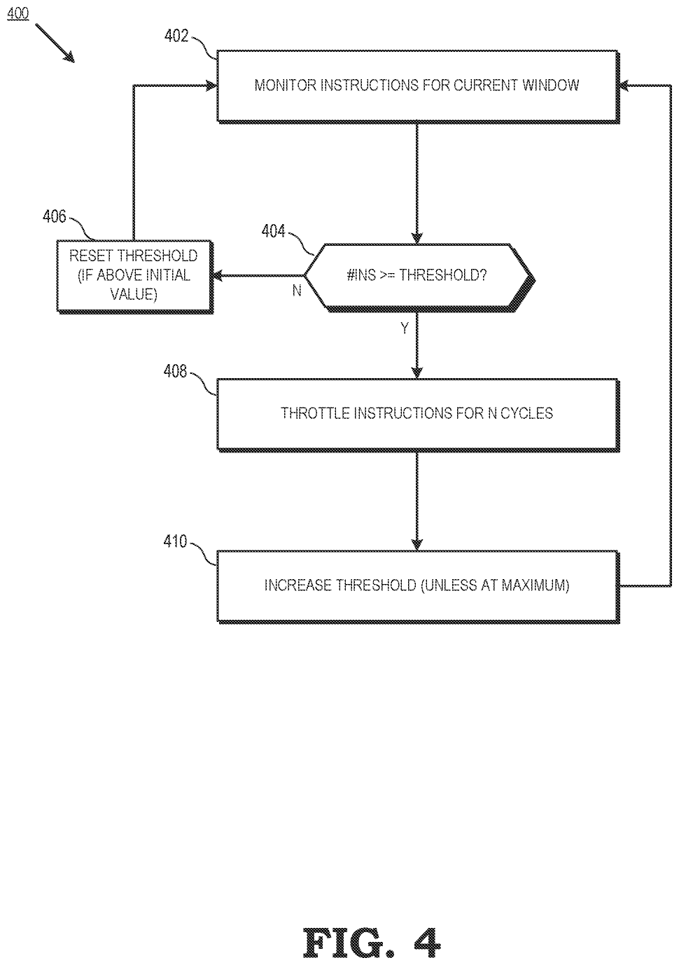

FIG. 4 is a flow diagram of a method 400 of throttling instructions at a processing unit in accordance with some embodiments. For purposes of description, the method 400 is described with respect to an example implementation at the GPU 100, and at the flow control circuitry 108. However, it will be appreciated that in other embodiments the method 400 is implemented at processing units having a different configuration.

At block 402, the flow control circuitry 108 monitors the number of instructions received at the instruction arbiter 106 for the current instruction window 325. In some embodiments, the flow control circuitry 108 implements the instruction window 325 as a running counter that is adjusted each cycle based on whether an instruction has been provided or not been provided by the instruction buffers 104 for the current cycle. The flow control circuitry 108 thus provides a sliding time window over the last N cycles, and a count of the number of instructions received over that sliding time window.

At block 404, the flow control circuitry 108 compares the number of instructions received over the instruction window 325 to the instruction threshold 324. If the number of instructions are below the instruction threshold 324, the method flow moves to block 406 and the throttle control circuitry 330 resets the instruction threshold 324 to an initial value. In some embodiments, the instruction threshold 324 is based on the maximum number of instructions that are able to be concurrently executed at the SIMD units 110, and the initial value is set at a level (e.g. fifty percent of the maximum number of instructions) such that execution of the threshold number of instructions does not result in a large amount of current being drawn by the SIMD units 110. The method flow returns to block 402.

Returning to block 404, if the number of received instructions for the current instruction window 325 matches or exceeds the instruction threshold 324, the method flow proceeds to block 408 and the throttle control circuitry 330 asserts the throttle control signal 112, thus temporarily pausing, for N cycles, the provision of instructions from the instruction buffers 104. The method flow moves to block 410 and the throttle control circuitry 330 increases the instruction threshold 324 by a specified step size, up to a maximum value, and the method flow returns to block 402. The flow control circuitry 108 thus gradually increases the maximum rate at which instructions are provided to the SIMD units 110, so that the circuitry activity and corresponding current at the SIMD units 110 does not change rapidly, but the instruction throughput at the SIMD units 110 is maintained at a high level.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors. Further, any of the various elements of the above-described figures are, in various implementations, implemented as one of software executing on a processor, hardware that is hard-wired (e.g., circuitry) to perform the various operations described herein, or a combination thereof.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
identifying, at a processing unit, a first number of instructions dispatched during a first instruction window; and
in response to the first number of instructions exceeding a first threshold throttling dispatch of instructions at the processing unit for a first amount of time.

2. The method of claim 1, further comprising:
identifying, at a processing unit, a second number of instructions dispatched during a second instruction window; and
in response to the second number of instructions exceeding a second threshold throttling dispatch of instructions at the processing unit for a first amount of time.

3. The method of claim 2, wherein the second threshold is different than the first threshold.

4. The method of claim 3, further comprising setting the second threshold in response to the first number of instructions exceeding the first threshold.

5. The method of claim 4, wherein a step size between the first threshold and the second threshold is a programmable value.

6. The method of claim 1, wherein the first threshold is based on a maximum workload of instructions able to be concurrently processed at the processing unit.

7. The method of claim 1, wherein identifying the first number of instructions comprises identifying a number of instructions of a specified type.

8. The method of claim 7, wherein identifying the first number of instructions comprises filtering instructions of a different type than the specified type.

9. The method of claim 7, wherein the specified type comprises instructions associated with a specified level of current at the processing unit.

10. A method, comprising:
identifying, based on a sliding time window, a number of instructions of a specified type dispatched for execution at a processing unit; and
in response to the number of instructions exceeding a threshold, throttling the dispatch of instructions for execution at the processing unit.

11. The method of claim 10, further comprising:
increasing in response to the throttling the dispatch of instructions.

12. A processing unit comprising:
a set of instruction buffers to dispatch instructions for execution; and
flow control circuitry to throttle dispatch of instructions from the set of instruction buffers in response to identifying that a first number of instructions dispatched during a first instruction window exceed a first threshold.

13. The processing unit of claim 12, wherein the flow control circuitry is to:
throttle dispatch of instructions in response to a second number of instructions dispatched during a second instruction window exceed a second threshold.

14. The processing unit of claim 13, wherein the second threshold is different than the first threshold.

15. The processing unit of claim 14, further comprising setting the second threshold in response to the first number of instructions exceeding the first threshold.

16. The processing unit of claim 15, wherein a step size between the first threshold and the second threshold is a programmable value.

17. The processing unit of claim 12, wherein the first threshold is based on a maximum workload of instructions able to be concurrently processed at the processing unit.

18. The processing unit of claim 12, wherein the flow control circuitry is to identify the first number of instructions by identifying a number of instructions of a specified type.

19. The processing unit of claim 18, wherein the flow control circuitry is to identify the first number of instructions by filtering instructions of a different type than the specified type.

20. The processing unit of claim 18, wherein the specified type comprises instructions associated with a specified level of current at the processing unit.
